(19) United States
(12) Patent Application Publication
(10) Pub. No.: US 2021/0138940 A1
(43) Pub. Date: May 13, 2021

(54) VEHICLE SEAT COOLING SYSTEM

(71) Applicant: LEAR CORPORATION, Southfield, MI (US)

(72) Inventor: Kyle Smith, Beverly Hills, MI (US)

(73) Assignee: LEAR CORPORATION, Southfield, MI (US)

(21) Appl. No.: 16/681,984

(22) Filed: Nov. 13, 2019

(51) Int. Cl. B60N 2/56

(52) U.S. Cl. CPC B60N 2/565; B60N 2/5635

(57) ABSTRACT

A seat for a vehicle may include a seat bottom having a top surface, and a seat back, extending upward from the seat bottom, and having a front surface. the seat may also include a seat cooling system including perforations in the front surface connected to air flow passages in the seat back, a thermoelectric device in the seat bottom having a cold side facing the top surface and an opposed hot side facing downward toward a hot side air passage, a duct configured to direct air from the air flow passages into the hot side air passage, and a blower configured to create air flow through the perforations, through the air flow passages, through the duct and through the hot side air passage.

### BACKGROUND OF THE INVENTION

The present invention relates to a seat for a vehicle and more particularly a climate controlled seat.

Conventional vehicles include heating, ventilation and air conditioning (HVAC) systems to provide comfort to those in the vehicle interior. In more recent vehicles, in order to further increase the comfort of vehicle occupants, some vehicles now also include HVAC systems within the vehicle seats themselves. While such seat HVAC systems improve passenger comfort, this generally increases the cost and complexity of the vehicle seat, in addition to the space taken up within the seat for the seat HVAC components.

### SUMMARY OF THE INVENTION

An embodiment contemplates a seat for a vehicle including a seat bottom having a top surface; a seat back, extending upward from the seat bottom, and having a front surface; and a seat cooling system including perforations in the front surface connected to air flow passages in the seat back, a thermoelectric device in the seat bottom having a cold side facing the top surface and an opposed hot side facing downward toward a hot side air passage, a duct configured to direct air from the air flow passages into the hot side air passage, and a blower configured to create air flow through the perforations, through the air flow passages, through the duct and through the hot side air passage.

An embodiment contemplates a seat for a vehicle comprising a seat bottom; a seat back, extending upward from the seat bottom, and having a front surface; and a seat cooling system including perforations in the front surface, a thermoelectric device in the seat bottom having a cold side facing upward and an opposed hot side facing downward toward a hot side air passage, a duct configured to direct air from the perforations into the hot side air passage, and a single blower configured to create air flow through the perforations, through the duct and through the hot side air passage.

An embodiment contemplates a method of cooling a seat in a vehicle comprising: activating a blower to pull air into a seat back through perforations in a front surface of the seat back; directing air flow, generated by the blower, from the perforations through a duct that extends to a hot side air flow passage adjacent to a hot side of a thermoelectric device mounted in a seat bottom; and flowing the air through the hot side air flow passage, with the air flow through the hot side air flow passage generated by the blower.

An advantage of an embodiment is that the seat cooling system may improve the efficiency of the seat cooling process while minimizing costs and packaging space for the system. Such a seat cooling system employs a seat bottom that is conduction cooled and a seat back that is convection cooled. This allows for the efficiency of sharing a common blower for both the seat back and seat bottom.

### BRIEF DESCRIPTION OF THE DRAWINGS

FIG. 1 is a schematic perspective view of a portion of a seat within a vehicle, showing a portion of the perforations in the seat back.

FIG. 2 is a schematic view of a portion of the vehicle seat, including the seat cooling system, and controls for the system.

### DETAILED DESCRIPTION

FIGS. 1 and 2 schematically illustrate portions of a seat 20 within a vehicle 22. The seat 20 may be mounted to a vehicle floor 24 within a passenger compartment 26. The seat 20 may include a seat bottom 28 upon which a buttocks and thighs 30 of a vehicle occupant 32 typically rest, a seat back 34 which supports a back 36 of the occupant 32, and a headrest 38 mounted on top of the seat back 34.

The seat 20 also includes a seat cooling system 40, which acts to cool portions of both the seat back 36 and the seat bottom 28. The seat cooling system 40 may include a seat back cooling/vent portion 42 and a seat bottom cooling portion 44.

The seat back portion 42 may include perforations 46 through a front surface 48 of the seat back 34 leading to internal air flow passages 50 within the seat back 34. The air flow passages 50 are connected to a blower (fan) 54, which may be located within the seat back 34. The blower 54 is connected to an electric power source 56, which selectively activates the blower 54 to draw air in through the perforations 46. A controller 58 may control the power being selectively supplied to the blower 54.

The seat bottom cooling portion 44 may include a thermoelectric device (TED) 60 located under a top surface 62 of the seat bottom 28 and connected to the power source 56. The TED 60 generally is a device whereby, when one passes an electrical current through a sandwich of two dissimilar metals, one side of the TED will become hot while the other side will become cold. TEDs are known to those skilled in the art and so will not be discussed in more detail herein.

For the TED 60 mounted in the present seat 20, a cold side 64 faces upward toward the top surface 62 while a hot side 66 faces downward toward the floor 24. Thus, when the electric power source 56 is activated by the controller 58, the cold side 64 adjacent to the top surface 62 will cool this surface 62 upon which the occupant 32 sits. Additionally, a hot side air flow passage 68 extends along the hot side 66 of the TED 60.

The seat cooling system 40 also includes one or more ducts 70 that extend from the blower 54 to the air flow passage 68, thus directing air discharged from the blower 54 through this air flow passage 68. While the blower 54 is shown in the seat back 34 adjacent to the internal air flow passages 50, the blower 54 may be mounted at any desired location along the duct(s) 70, so long as it is configured to draw air in through the perforations 46 and direct the air to the hot side air flow passage 68.

The operation of the seat cooling system 40 will now be discussed. Upon the controller 58 detecting a desire for cooling of the seat 20, the controller 58 activates the electric power source 56 to the blower 54 and TED 60. The blower 54 pulls air in through the perforations 46, directs the air through the duct 70, through the hot side passage 68 and out under the seat 20 (as indicated by the arrows in FIG. 2). Meanwhile, the electric power to the TED 60 causes the cold side 64 to cool while the hot side 66 heats up.

The air flow through the perforations 46 in the seat back 34 creates convention cooling/ventilation for the back 36 of the occupant 32. Additionally, the cold side 64 of the TED 60 cools the top surface 62 of the seat bottom 28, creating conduction cooling for the buttocks and thighs 30 of the occupant 32. The heat from the hot side 66 of the TED 60 is absorbed by the air flowing through the hot side passage 68 and is directed away from the seat bottom 28. Thus, the single blower 54 provides both seat back cooling/ventilation and seat bottom cooling. Accordingly, the occupant 32 receives cooling of the vehicle seat 20 while minimizing the cost and packaging space needed to provide this additional occupant comfort.

While certain embodiments of the present invention have been described in detail, those familiar with the art to which this invention relates will recognize various alternative designs and embodiments for practicing the invention as defined by the following claims.

1. A seat for a vehicle comprising:
a seat bottom having a top surface;
a seat back, extending upward from the seat bottom, and having a front surface; and
a seat cooling system including perforations in the front surface connected to air flow passages in the seat back, a thermoelectric device in the seat bottom having a cold side facing the top surface and an opposed hot side facing downward toward a hot side air passage, a duct configured to direct air from the air flow passages into the hot side air passage, and a blower configured to create air flow through the perforations, through the air flow passages, through the duct and through the hot side air passage.

2. The seat of claim 1 further including an electric power source operatively connected to the blower and the thermoelectric device.

3. The seat of claim 2 wherein the blower is mounted in the seat back.

4. The seat of claim 2 further including a controller selectively activating the electric power source to the blower and the thermoelectric device.

5. The seat of claim 1 wherein the blower is mounted in the seat back.

6. A seat for a vehicle comprising:
a seat bottom;
a seat back, extending upward from the seat bottom, and having a front surface; and
a seat cooling system including perforations in the front surface, a thermoelectric device in the seat bottom having a cold side facing upward and an opposed hot side facing downward toward a hot side air passage, a duct configured to direct air from the perforations into the hot side air passage, and a single blower configured to create air flow through the perforations, through the duct and through the hot side air passage.

7. The seat of claim 6 wherein the seat back includes air flow passages directing air from the perforations into the duct.

8. The seat of claim 6 wherein the blower is mounted in the seat back.

9. The seat of claim 6 further including an electric power source operatively connected to the blower and the thermoelectric device.

10. A method of cooling a seat in a vehicle comprising:
activating a blower to pull air into a seat back through perforations in a front surface of the seat back;
directing air flow, generated by the blower, from the perforations through a duct that extends to a hot side air flow passage adjacent to a hot side of a thermoelectric device mounted in a seat bottom; and
flowing the air through the hot side air flow passage, with the air flow through the hot side air flow passage generated by the blower.

11. The method of claim 10 wherein the blower is mounted in the seat back, pulling air through the perforations and pushing air into the duct.

12. The method of claim 10 further including activating an electric power source to provide electric power to the blower and the thermoelectric device.
